(19) United States
(12) Patent Application Publication
(10) Pub. No.: US 2025/0014318 A1
(43) Pub. Date: Jan. 9, 2025

(54) ARTIFICIAL INTELLIGENCE DEVICE FOR SENSING DEFECTIVE PRODUCTS ON BASIS OF PRODUCT IMAGES AND METHOD THEREFOR

(71) Applicant: LG MANAGEMENT DEVELOPMENT INSTITUTE CO., LTD., Seoul (KR)

(72) Inventors: Sangyun KIM, Seoul (KR); Byungjun Kang, Yongin-si (KR); Youngsan Koh, Seoul (KR); Jeeho Hyun, Seoul (KR); Seunghwan Kim, Seoul (KR)

(21) Appl. No.: 18/892,472

(22) Filed: Sep. 22, 2024

Related U.S. Application Data
(63) Continuation of application No. PCT/KR2023/003769, filed on Mar. 22, 2023.

(30) Foreign Application Priority Data
Mar. 23, 2022 (KR) 10-2022-0036260

(51) Int. Cl. G06V 10/774; G06T 7/00; G06V 10/764; G06V 10/82

(52) U.S. Cl. CPC G06V 10/774; G06T 7/0004; G06V 10/764; G06V 10/82; G06T 2207/20081; G06T 2207/20084

(57) ABSTRACT

An artificial intelligence device includes: a memory to store a first normal product image; a learning processor to train an image restoration model through inputting the first normal product image into the image restoration model as learning data to output a normal restored image similar to the first normal product image; and a processor configured to: modify the first normal product image to generate a first normal modified image belonging to a normal classification, and increase a number of a second normal product image belonging to the normal classification, modify at least one of the second normal product image to generate an abnormal modified image belonging to an abnormal classification, and input the abnormal modified image into the image restoration model to acquire an abnormal restored image output from the image restoration model.

### CROSS REFERENCE TO RELATED APPLICATIONS

This application is a Bypass Continuation of International Patent Application No. PCT/KR2023/003769, filed on Mar. 22, 2023, which claims priority from and the benefit of Korean Patent Application No. 10-2022-0036260, filed on Mar. 23, 2022, each of which is hereby incorporated by reference for all purposes as if fully set forth herein.

### BACKGROUND

### Field

Embodiments of the invention relate generally to an artificial intelligence device for sensing defective products on the basis of product images and method therefor, and more specifically, to an artificial intelligence device that can determine whether a product is normal or defective by determining defects on the basis of images captured from the product being produced and method therefor.

### Discussion of Background

During a production process, a procedure is implemented to inspect products for defects.

When inspecting whether a product is defective, a vision inspection method may be utilized, where workers use various auxiliary devices to inspect products in accordance with the speed of the process in production facilities. However, the accuracy and efficiency of the vision inspection method can vary depending on the operator's skill, concentration, and fatigue.

To address these limitations of vision inspection methods, a vision inspection system capable of detecting product defects during the production process has recently been introduced.

The vision inspection system is a system that can determine whether a product is defective based on the image of the product.

However, to develop such a non-point inspection system, images of both normal products and defective products are necessary. In actual production sites, however, the frequency (or a production rate) of defects is low, resulting in a scarcity of detective product images compared to non-defective, normal products images.

Accordingly, there is a need for technology that can facilitate the development of a vision inspection system, particularly in acquiring images of defective products.

The above information disclosed in this Background section is only for understanding of the background of the inventive concepts, and therefore, it may contain information that does that constitute prior art.

### SUMMARY

Artificial intelligence device for sensing defective products on the basis of product images and method therefor according to embodiments of the invention are capable of distinguishing between normal and defective products by constructing a large amount of learning data using image data of normal products and training an artificial neural network.

Artificial intelligence device for sensing defective products on the basis of product images and method therefor according to embodiments of the inventions are also capable of automatically distinguishing between normal products and defective products based on product images acquired during the production process.

Additional features of the inventive concepts will be set forth in the description which follows, and in part will be apparent from the description, or may be learned by practice of the inventive concepts.

According to one or more embodiments of the invention, an artificial intelligence device includes: a memory configured to store a first normal product image; a learning processor configured to train an image restoration model through inputting the first normal product image into the image restoration model as learning data to output a normal restored image similar to the first normal product image; and a processor configured to: modify the first normal product image to generate a first normal modified image belonging to a normal classification, and increase a number of a second normal product image belonging to the normal classification, the second normal product image including the first normal product image and the first normal modified image, modify at least one of the second normal product image belonging to the normal classification to generate an abnormal modified image belonging to an abnormal classification, and input the abnormal modified image into the image restoration model to acquire an abnormal restored image output from the image restoration model, wherein the processor is further configured to: acquire an inspection product image for a product to be inspected, input the inspection product image into the image restoration model, and acquire a restored inspection product image output from the image restoration model, and determine whether the product to be inspected is defective by using a distance between a first expression vector of the inspection product image and a second expression vector of the restored inspection product image.

The learning processor may be configured to train the image restored model so that a mean square error (MSE) of a pixel value of the first normal product image and a pixel value of the first normal restored image is minimized.

The processor may be configured to apply at least one of brightness change, color change, contrast change, rotation, and rescale to the first normal product image to generate the second normal product image belonging to the normal classification and increase the number of the second normal product image.

The processor may be configured to apply at least one of cut-out, cut-paste, and noise addition to the at least one second normal product image belonging to the normal classification to generate the abnormal modified image belonging to the abnormal classification.

The learning processor may be configured to train a feature extraction model by inputting the second normal product image belonging to the normal classification, the abnormal modified image, and the abnormal restored image as learning data into the feature extraction model which outputs an expression vector for the input image data.

The learning processor may be configured to perform contrastive learning on the feature extraction model so that a distance between an expression vector of the second normal product image belonging to the normal classification and an expression vector of the abnormal restored image is less than a distance between an expression vector of the abnormal modified image and the expression vector of the abnormal restored image.

The learning processor may be configured to input the second normal product image belonging to the normal classification as positive sample input data into the feature extraction model, input the abnormal modified image as negative sample input data into the feature extraction model, input the abnormal restored image as anchor input data into the feature extraction model, and train the feature extraction model through a triplet loss function.

The processor may be configured to acquire a distance between the first expression vector and the second expression vector, and determine whether the product to be inspected is defective according to the distance between the first expression vector and the second expression vector.

The processor may be configured to determine that the product to be inspected is normal when the distance between the first expression vector and the second expression vector is less than or equal to a predetermined defect reference value, and determine that the product to be inspected is defective when the distance between the first expression vector and the second expression vector exceeds the predetermined defect reference value.

According to another embodiment of the invention, a method for detecting a defective product, the method includes the steps of: acquiring, by a processor, a first normal product image; training, by a learning processor, an image restoration model through inputting the first normal product image into the image restoration model as learning data to output a normal restored image similar to the first normal product image; modifying, by the processor, the first normal product image to generate a first normal modified image belonging to a normal classification and increasing a number of a second normal product image belonging to the normal classification, the second normal product image including the first normal product image and the first normal modified image; modifying, by the processor, at least one of the second normal product image belonging to the normal classification to generate an abnormal modified image belonging to an abnormal classification; inputting, by the processor, the abnormal modified image into the image restoration model to acquire an abnormal restored image output from the image restoration model; acquiring, by the processor, an inspection product image for a product to be inspected; inputting, by the processor, the inspection product image into the image restoration model, and acquiring a restored inspection product image output from the image restoration model; and determining, by the processor, whether the product to be inspected is defective by using a distance between a first expression vector of the inspection product image and a second expression vector of the restored inspection product image.

The step of training the image restoration model may include the step of training the image restoration model so that a mean square error (MSE) of a pixel value of the first normal product image and a pixel value of the first normal restored image is minimized.

The step of modifying the first normal product image may include a step of applying at least one of brightness change, color change, contrast change, rotation, and rescale to the first normal product image to generate the second normal product image belonging to the normal classification and increase the number of the second normal product image.

The step of modifying the second normal product image may include a step of applying at least one of cut-out, cut-paste, and noise addition to the at least one second normal product image belonging to the normal classification to generate the abnormal modified image belonging to the abnormal classification.

The method may further include the step of: training, by the learning processor, a feature extraction model by inputting the second normal product image belonging to the normal classification, the abnormal modified image, and the abnormal restored image as learning data into the feature extraction model which outputs an expression vector for the input image data.

The step of training the feature extraction model may include the step of performing contrastive learning on the feature extraction model so that a distance between an expression vector of the second normal product image belonging to the normal classification and an expression vector of the abnormal restored image is less than a distance between an expression vector of the abnormal modified image and the expression vector of the abnormal restored image.

The step of training the feature extraction model may include the steps of: inputting the second normal product image belonging to the normal classification as positive sample input data into the feature extraction model; inputting the abnormal modified image as negative sample input data into the feature extraction model; inputting the abnormal restored image as anchor input data into the feature extraction model; and training the feature extraction model through a triplet loss function.

The step of determining whether the product to be inspected is defective may include the steps of: acquiring a distance between the first expression vector and the second expression vector; and determining whether the product to be inspected is defective according to the distance between the first expression vector and the second expression vector.

The step of determining whether the product to be inspected is defective may further include the steps of: determining that the product to be inspected is normal when the distance between the first expression vector and the second expression vector is less than or equal to a predetermined defect reference value; and determining that the product to be inspected is defective when the distance between the first expression vector and the second expression vector exceeds the predetermined defect reference value.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of an artificial intelligence device according to an embodiment of the invention.

FIG. 2 is a block diagram of an artificial intelligence server according to an embodiment of the invention.

FIG. 3 is a flowchart illustrating a method of operating an artificial intelligence device according to an embodiment of the invention.

FIG. 4 is a diagram showing a method of acquiring an image for a product according to an embodiment of the invention.

FIG. 5 is a diagram showing an image restoration model according to an embodiment of the invention.

FIG. 6 is a diagram showing a normal product image according to an embodiment of the invention.

FIG. 7 is a diagram showing an abnormal modified image according to an embodiment of the invention.

FIG. 8 is a diagram showing a method of detecting defective products according to an embodiment of the invention.

FIG. 9 is a diagram showing a feature extraction model according to an embodiment of the invention.

FIG. 10 is a flowchart illustrating a method of detecting defective products according to an embodiment of the invention.

FIG. 11 is a diagram showing the method of detecting defective products of FIG. 10.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the invention will be described in more detail with reference to accompanying drawings. Regardless of the drawing's symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In addition, when it is determined that the detailed description of the related known technology may obscure the gist of embodiments disclosed herein in describing the embodiments, a detailed description thereof will be omitted. Additionally, the accompanying drawings are used to help easily understanding embodiments disclosed herein but the inventive concepts are not limited to such embodiments. It should be understood that all of variations, equivalents or substitutes contained in the inventive concepts are also included.

### <Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

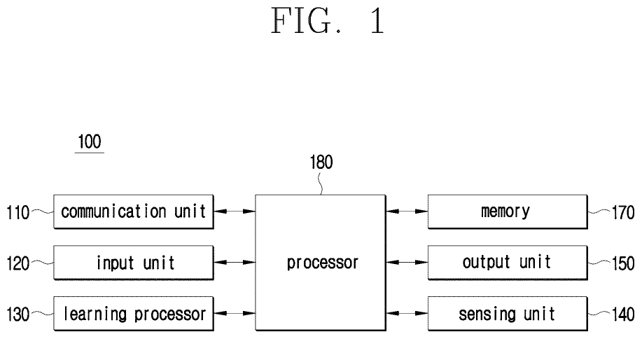

FIG. 1 is a block diagram of an artificial intelligence device according to an embodiment of the invention.

An AI device 100 may be implemented by a stationary device or mobile device, such as a TV, a projector, a mobile phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, a processor 180, and the like.

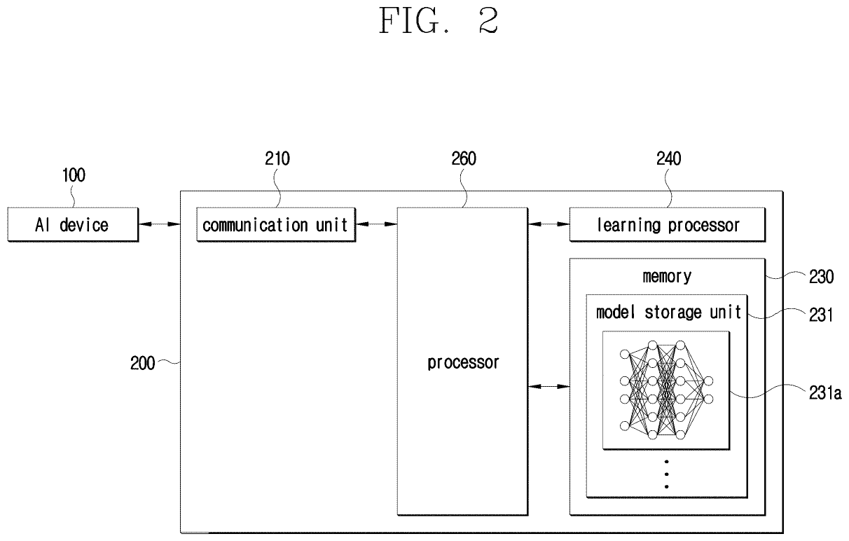

The communication unit 110 may transmit and receive data to and from external devices such as other AI devices and an AI server 200 shown in FIG. 2 by using wire/wireless communication technology. For example, the communication unit 110 may transmit and receive sensor information, a user input, a learning model, and a control signal to and from external devices.

The communication technology used by the communication unit 110 may include Global System for Mobile communication (GSM), Code Division Multi Access (CDMA), Long Term Evolution (LTE), 5G, WLAN (Wireless LAN), Wireless-Fidelity (Wi-Fi), Bluetooth™, Radio Frequency Identification (RFID), Infrared Data Association (IrDA), ZigBee, Near Field Communication (NFC), and the like.

The input unit 120 may acquire various kinds of data.

The input unit 120 may include a camera for inputting a video signal, a microphone for receiving an audio signal, a user input unit for receiving information from a user, and the like. In some embodiments, the camera or microphone may be treated as a sensor, and the signal acquired from the camera or microphone may be referred to as sensing data or sensor information.

The input unit 120 may acquire a learning data for model learning and an input data to be used when an output is acquired by using learning model. The input unit 120 may acquire raw input data. In this case, the processor 180 or learning processor 130 may extract an input feature by preprocessing the input data.

The learning processor 130 may train a model composed of an artificial neural network by using learning data. Here, the learned artificial neural network may be referred to as a learning model. The learning model may be used to an infer result value for new input data rather than learning data, and the inferred value may be used as a basis for determination to perform a certain operation.

The learning processor 130 may perform AI processing together with a learning processor 240 of the AI server 200.

The learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, a RGB sensor, an IR sensor, a fingerprint recognition sensor, an ultrasonic sensor, an optical sensor, a microphone, a lidar, and a radar, without being limited thereto.

The output unit 150 may generate an output related to a visual sense, auditory sense, or haptic sense.

The output unit 150 may include a display unit for outputting visual information, a speaker for outputting auditory information, a haptic module for outputting haptic information, and the like.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or memory 170. The processor 180 may control the components of the AI device 100 to execute the predicted operation or the operation determined to be desirable among the at least one executable operation.

For example, when the connection of an external device is required to perform the determined operation, the processor 180 may generate a control signal for controlling the corresponding external device and may transmit the generated control signal to the external device.

The processor 180 may acquire intention information for the user input and may determine the user's requirements based on the acquired intention information.

More particularly, the processor 180 may acquire a restored image of an image input through an image restoration engine on an image-by-image basis, or classify and judge the image by extracting the features of the image (hereinafter referred to as an expression vector) through an image classification and judgment engine including an image feature extraction network.

At least one of the image restoration engine and the image classification and judgment engine including an image feature extraction network may be configured as an artificial neural network, at least part of which is trained according to a machine learning algorithm. In addition, at least one of the image restoration engine and the image classification and judgment engine including an image feature extraction network may be trained by the learning processor 130, may be learned by the learning processor 240 of the AI server 200, or may be learned by their distributed processing.

The processor 180 may collect history information including the operation contents of the AI device 100, the user's feedback on the operation, and the like. The processor 180 may further store the collected history information in the memory 170 or learning processor 130, or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 is a block diagram of an AI server according to an embodiment of the invention.

Referring to FIG. 2, the AI server 200 may refer to a device that trains an artificial neural network by using a machine learning algorithm or uses a trained artificial neural network. The AI server 200 may include a plurality of servers to perform distributed processing, or may be defined as a 5G network. In some embodiments, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device, such as the AI device 100.

The memory 230 may include a model storage unit 231. The model storage unit 231 may store a learning or learned model (or an artificial neural network 231a) through the learning processor 240.

The learning processor 240 may train the artificial neural network 231a by using the learning data. The learning model may be used in a state of being mounted on the AI server 200 of the artificial neural network, or may be used in a state of being mounted on an external device such as the AI device 100.

The learning model may be implemented as a hardware, software, or a combination of hardware and software. If all or part of the learning models are implemented as a software, one or more instructions that constitute the learning model may be stored in memory 230.

The processor 260 may infer the result value for new input data by using the learning model and may generate a response or control command based on the inferred result value.

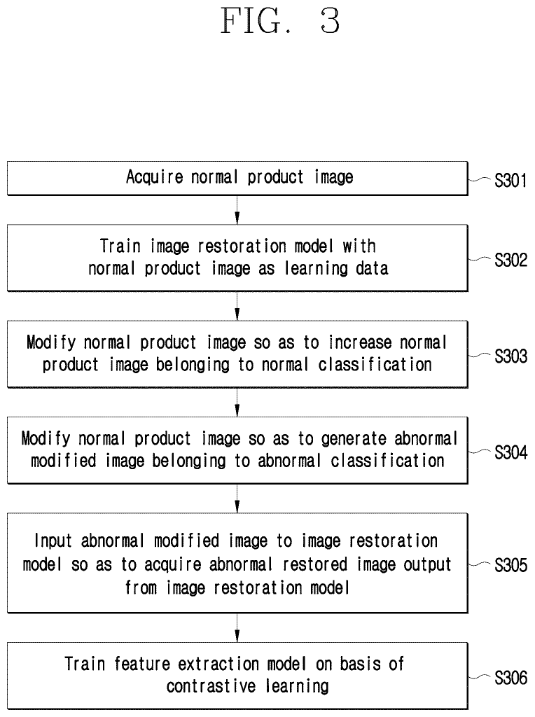

FIG. 3 is a flowchart illustrating a method of operating an artificial intelligence device according to an embodiment of the invention.

According to an embodiment, the processor 180 of the AI device 100 may acquire a normal product image as learning data (S301). The normal product image may be an image stored in the memory 170 of the AI device 100, or a stored image received from an external device through the communication unit 110 of the AI device 100.

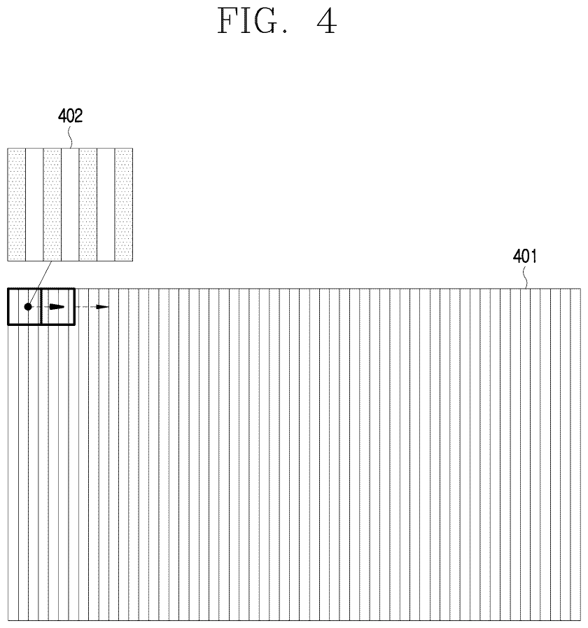

A normal product image may refer to an image taken from a normal product without any defects among the products being produced. In some embodiments, the normal product image may be a partial image corresponding to a predetermined size of the entire image taken from the normal product. The step of acquiring a normal product image and the additional steps of the method of operating the artificial intelligence device illustrated in FIG. 3 will be further described below with reference to FIGS. 4 to 9.

FIG. 4 is a diagram showing a method of acquiring an image for a product according to an embodiment of the invention.

Referring to FIG. 4, the processor 180 may acquire a partial image 402 corresponding to a predetermined size of an entire product image 401 taken from a product.

For example, the processor 180 may acquire the partial image 402 corresponding to a predetermined size while going through each part of the entire product image 401.

If the entire product image 401 of the product is an image of a normal product, the processor 180 may acquire each partial image 402 as a normal product image. Accordingly, the processor 180 may acquire learning data necessary to train an artificial neural network model that determines whether a product is normal or defective based on the partial image of the product.

Meanwhile, referring back to FIG. 3, the learning processor 130 of AI device 100 may train an image restoration model using the acquired normal product image as learning data (S302).

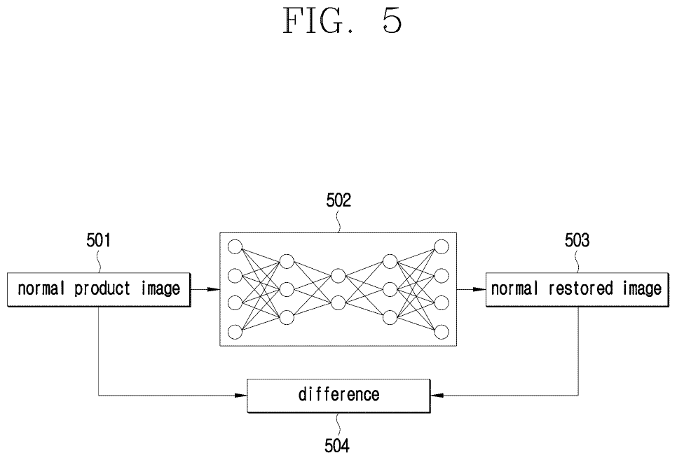

FIG. 5 is a diagram showing an image restoration model according to an embodiment of the invention.

Referring to FIG. 5, the learning processor 130 may input a normal product image 501 into an image restoration model 502, and output a normal restored image 503 that is reconstructed and restored from the image restoration model 502.

The image restoration model 502 may be an artificial neural network (ANN) trained to output restoration data that is similar to the input data. The artificial neural network (ANN) is a model used in machine learning and may mean a whole model of problem-solving ability which is composed of artificial neurons (nodes) that form a network by synaptic connections.

For example, the image restoration model 502 may be an autoencoder-based artificial neural network model. The autoencoder-based image restoration model 502 may include an encoder portion and a decoder portion. The encoder portion may dimensionally reduce the data by making the number of neurons in the hidden layer smaller than the number of neurons in the input layer. The decoder portion may reconstruct the data by dimensionally expanding the data from the hidden layer again and has an output layer having the same number of neurons as the number of neurons in the input layer, but is not limited thereto.

In another embodiment, the image restoration model 502 may be an artificial neural network model based on a generative adversarial network (GAN). The generative adversarial network (GAN) may be an artificial neural network, in which a generator and a discriminator are adversarially learned, but is not limited thereto.

In some embodiments, the image restoration model 502 may be an artificial neural network model that is trained to output a normal restored image that is reconstructed and restored to be similar to the input normal product image.

As such, when the normal product image 501 or image modified from the normal product image is input, the image restoration model 502 may output the normal restored image 503 similar to the input normal product image or normal product image.

Meanwhile, the learning processor 130 may train the image restoration model 502 so that a difference 504 between the pixel value of the normal product image 501 and the pixel value of the normal restored image 503 is minimized or is at least reduced to a value below a predetermined threshold. For example, the learning processor 130 may train the image restoration model 502 so that a mean square error (MSE) of the pixel value of the normal product image 501 and pixel value of the normal restored image 503 is minimized or is at least reduced to a value below a predetermined threshold.

Meanwhile, referring back to FIG. 3, the processor 180 may increase the number of normal product images belonging to a normal classification by modifying the normal product image (S303).

When acquiring the normal product images for products produced to construct learning data, the number of normal product images that can be acquired may be limited. Accordingly, the processor 180 may increase the number of normal product images belonging to a positive class (or a normal class) by applying a predetermined modification to the normal product image.

For example, the processor 180 may apply at least one of brightness change, color change, contrast change, rotation, and rescale to the normal product image to increase the normal product image belonging to the normal classification.

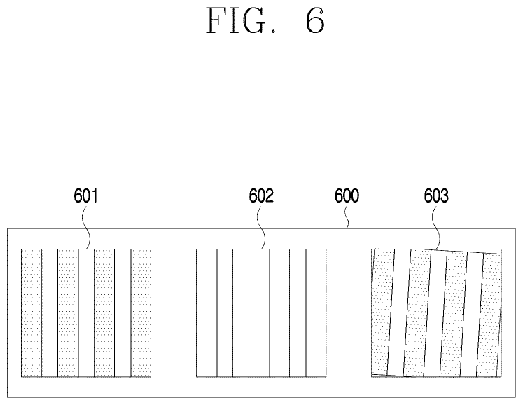

FIG. 6 is a diagram showing a normal product image according to an embodiment of the invention.

The processor 180 may increase the normal product images 600 belonging to the normal classification. The processor 180 may lower the brightness of the original normal product image 601 to generate a normal product image 602 that is darker than the original normal product image 601. In addition, the processor 180 may apply rotation to the original normal product image 601 to generate a normal product image 603 in which the original normal product image 601 is rotated at a predetermined angle.

Meanwhile, referring back to FIG. 3, the processor 180 may modify a normal product image belonging to the normal classification to generate an abnormal modified image belonging to an abnormal classification (S304).

When acquiring abnormal product images for products produced to construct learning data, the number of abnormal product images that can be acquired may be particularly limited. In particular, since the defect rate in the production process is generally low and the causes of defects are very diverse, it is difficult to acquire images of abnormal products. Accordingly, the processor 180 may modify a normal product image belonging to the normal classification to generate an abnormal modified image belonging to the abnormal classification (or a negative class).

For example, the processor 180 may apply at least one of cut-out, cut-paste, and noise addition to a normal product image belonging to the normal classification to generate an abnormal modified image belonging to the abnormal classification.

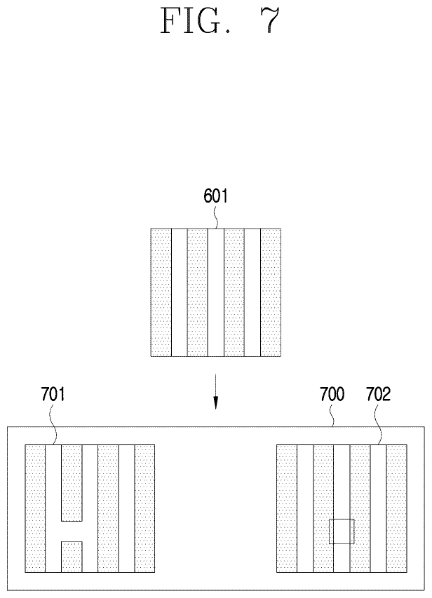

FIG. 7 is a diagram showing an abnormal modified image according to an embodiment of the invention.

The processor 180 may generate an abnormal modified image 701 belonging to the abnormal classification 700 by cutting out a predetermined image portion of the normal product image 601 belonging to the normal classification. In addition, the processor 180 may generate an abnormal modified image 702 belonging to the abnormal classification 700 by cutting and pasting a predetermined image portion of the normal product image 601 belonging to the normal classification.

Meanwhile, referring back to FIG. 3, the processor 180 may input an abnormal modified image into an image restoration model and acquire an abnormal restored image output from the image restoration model (S305). As described above, the image restoration model learns only from the normal product images, and the abnormal restored image according to embodiments is an image restored as a restoration image of a normal product that is most similar to the abnormal modified image.

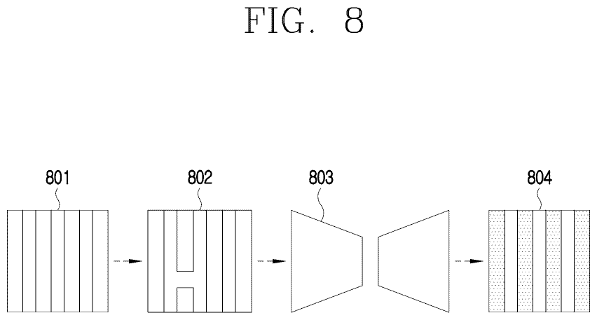

FIG. 8 is a diagram showing a method of detecting defective products according to an embodiment of the invention.

The processor 180 may input an abnormal modified image 802, which is modified based on a normal product image 801, into an image restoration model 803.

The processor 180 may acquire an abnormal restored image 804 output from the image restoration model 803.

Meanwhile, referring back to FIG. 3, the learning processor 130 may train feature extraction model on the basis of contrastive learning (S306). More particularly, the learning processor 130 may input the normal product image belonging to the normal classification, abnormal modified image, and abnormal restored image into a feature extraction model, and perform contrastive learning on the feature extraction model. In this manner, a distance between the expression vector of the normal product image belonging to the normal classification output from the feature extraction model and the expression vector of the abnormal restored image becomes closer, and a distance between the expression vector of the abnormal modified image and the expression vector of the abnormal restored image becomes distant. In some embodiments, the distance between the expression vector of the normal product image belonging to the normal classification output from the feature extraction model and the expression vector of the abnormal restored image may be less than the distance between the expression vector of the abnormal modified image and the expression vector of the abnormal restored image. Meanwhile, the feature extraction model may be an artificial neural network model that receives predetermined image data and outputs an expression vector for the input predetermined image data.

In addition, the learning processor 130 may train the feature extraction model through a triplet loss function by inputting the normal product image belonging to the normal classification as positive sample input data, the abnormal modified image as negative sample input data, and the abnormal restored image as anchor input data.

The triplet loss function can be as follows.

$$L ( A , P , N ) = max ( {‖ f ( A ) - f ( P ) ‖}^{2} - {‖ f ( A ) - f ( N ) ‖}^{2} + α , 0 ) \qquad [ Equation 1 ]$$

A denotes the anchor input data, P denotes the positive sample input data, and N denotes the negative sample input data. Also, a denotes the margin between the positive and negative pairs, and f denotes the embedding or expression vector.

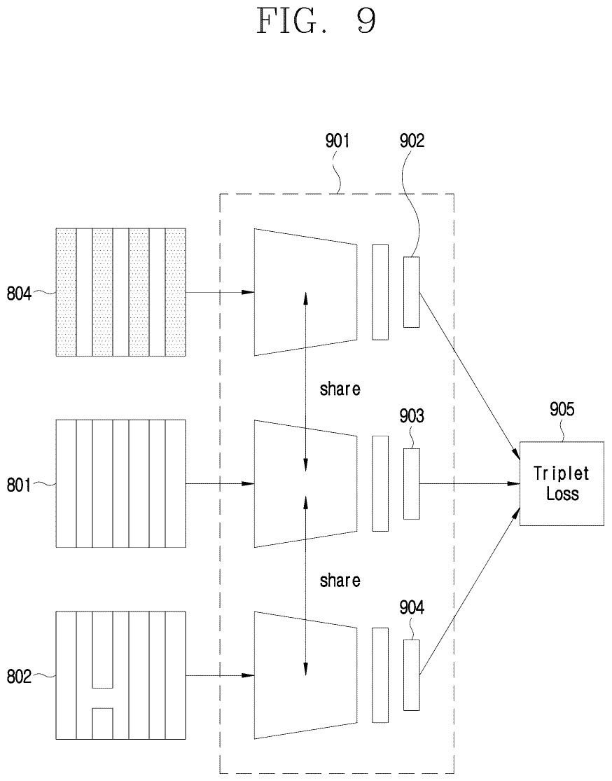

FIG. 9 is a diagram showing a feature extraction model according to an embodiment of the invention.

The learning processor 130 may input the abnormal restored image 804 as anchor input data into a feature extraction model 901, input the normal product image 801 belonging to the normal classification as positive sample input data into the feature extraction model 901, input the abnormal modified image 802 as negative sample input data into the feature extraction model 901, and train the feature extraction model 901 through a triplet loss function 905 for each output expression vector (902, 903, 904).

Meanwhile, the processor 180 may use the image of the product to be inspected based on the learned image restoration model and feature extraction model to determine whether the product to be inspected is a normal product or a defective product.

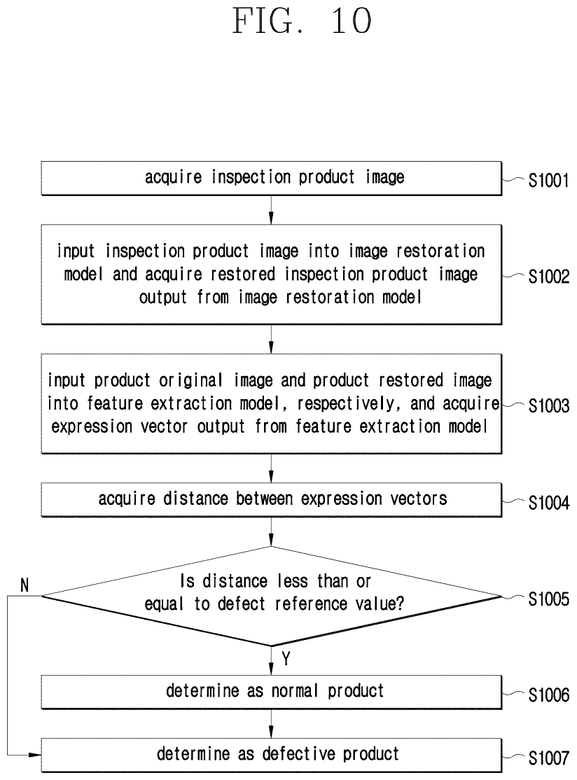

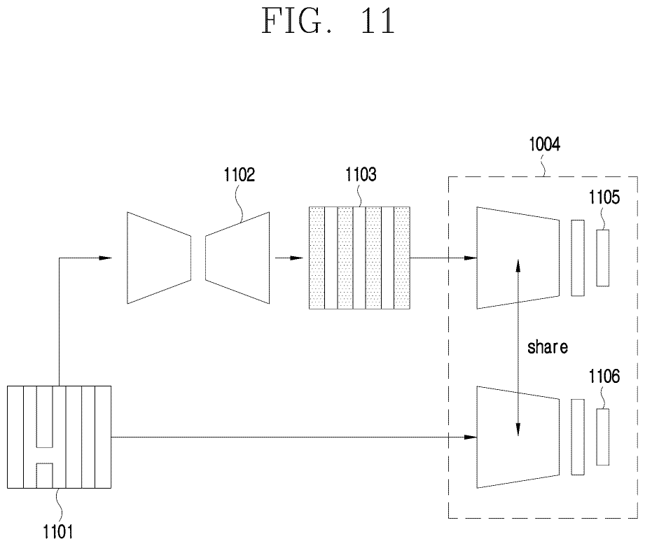

FIG. 10 is a flowchart illustrating a method of detecting defective products according to an embodiment of the invention. FIG. 11 is a diagram showing the method of detecting defective products of FIG. 10.

Referring to FIGS. 10 and 11, the processor 180 of AI device 100 may acquire an inspection product image 1101 for a product to be inspected (S1001). The inspection product image may be an image taken using a camera, etc. during the production or inspection process of the product. The inspection product image may be an image stored in the memory 170 of the AI device 100, or an image received and stored from an external device through the communication unit 110 of the AI device 100.

As shown in FIG. 11, the processor 180 may input the inspection product image 1101 into the image restoration model 1102 and acquire the restored inspection product image 1103 output from the image restoration model 1102 (S1002).

The processor 180 may input the inspection product image 1101 and restored inspection product image 1103 into a feature extraction model 1004 to generate a first expression vector 1106 of the inspection product image 1101 output from the feature extraction model 1004 and a second expression vector 1105 of the restored inspection product image 1103, respectively (S1003).

The processor 180 may also acquire a distance between the first expression vector 1106 and the second expression vector 1105 (S1004).

The processor 180 may determine whether the product to be inspected is defective according to the distance between the first expression vector 1106 and the second expression vector 1105.

The processor 180 may determine whether the distance between the first expression vector 1106 and the second expression vector 1105 is less than or equal to a predetermined defect reference value (S1005).

The processor 180 may determine that the product to be inspected is normal when the distance between the first expression vector 1106 and the second expression vector 1105 is less than or equal to a predetermined defect reference value (S1006).

The processor 180 may determine that the product to be inspected is defective when the distance between the first expression vector 1106 and the second expression vector 1105 exceeds a predetermined defect reference value (S1007).

The above-described embodiments may be realized as computer readable codes in a program recording medium. The computer readable medium includes all kinds of recording devices that store data that can be read by a computer system. For example, the computer readable medium includes a hard disk drive (HDD), a solid state disk (SSD), a silicon disk drive (SDD), ROM, RAM, CD-ROM, a magnetic tape, a floppy disk, an optical data storage device, and the like. Also, the computer may include the processor 180 of an artificial intelligence device 100.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An artificial intelligence device, comprising:
a memory configured to store a first normal product image;
a learning processor configured to train an image restoration model through inputting the first normal product image into the image restoration model as learning data to output a normal restored image similar to the first normal product image; and
a processor configured to:
i) modify the first normal product image to generate a first normal modified image belonging to a normal classification, and increase a number of a second normal product image belonging to the normal classification, the second normal product image including the first normal product image and the first normal modified image;
ii) modify at least one of the second normal product image belonging to the normal classification to generate an abnormal modified image belonging to an abnormal classification; and
iii) input the abnormal modified image into the image restoration model to acquire an abnormal restored image output from the image restoration model,
wherein the processor is further configured to:
a) acquire an inspection product image for a product to be inspected;
b) input the inspection product image into the image restoration model, and
acquire a restored inspection product image output from the image restoration model; and
c) determine whether the product to be inspected is defective by using a distance between a first expression vector of the inspection product image and a second expression vector of the restored inspection product image.

2. The artificial intelligence device of claim 1, wherein the learning processor is configured to train the image restored model so that a mean square error (MSE) of a pixel value of the first normal product image and a pixel value of the first normal restored image is minimized.

3. The artificial intelligence device of claim 1, wherein the processor is configured to apply at least one of brightness change, color change, contrast change, rotation, and rescale to the first normal product image to generate the second normal product image belonging to the normal classification and increase the number of the second normal product image.

4. The artificial intelligence device of claim 3, wherein the processor is configured to apply at least one of cut-out, cut-paste, and noise addition to the at least one second normal product image belonging to the normal classification to generate the abnormal modified image belonging to the abnormal classification.

5. The artificial intelligence device of claim 1, wherein the learning processor is configured to train a feature extraction model by inputting the second normal product image belonging to the normal classification, the abnormal modified image, and the abnormal restored image as learning data into the feature extraction model which outputs an expression vector for the input image data.

6. The artificial intelligence device of claim 5, wherein the learning processor is configured to perform contrastive learning on the feature extraction model so that a distance between an expression vector of the second normal product image belonging to the normal classification and an expression vector of the abnormal restored image is less than a distance between an expression vector of the abnormal modified image and the expression vector of the abnormal restored image.

7. The artificial intelligence device of claim 5, wherein the learning processor is configured to input the second normal product image belonging to the normal classification as positive sample input data into the feature extraction model, input the abnormal modified image as negative sample input data into the feature extraction model, input the abnormal restored image as anchor input data into the feature extraction model, and train the feature extraction model through a triplet loss function.

8. The artificial intelligence device of claim 1, wherein the processor is configured to acquire a distance between the first expression vector and the second expression vector, and determine whether the product to be inspected is defective according to the distance between the first expression vector and the second expression vector.

9. The artificial intelligence device of claim 8, wherein the processor is configured to determine that the product to be inspected is normal when the distance between the first expression vector and the second expression vector is less than or equal to a predetermined defect reference value, and determine that the product to be inspected is defective when the distance between the first expression vector and the second expression vector exceeds the predetermined defect reference value.

10. A method for detecting a defective product, comprising the steps of:
acquiring, by a processor, a first normal product image;
training, by a learning processor, an image restoration model through inputting the first normal product image into the image restoration model as learning data to output a normal restored image similar to the first normal product image;
modifying, by the processor, the first normal product image to generate a first normal modified image belonging to a normal classification and increasing a number of a second normal product image belonging to the normal classification, the second normal product image including the first normal product image and the first normal modified image;
modifying, by the processor, at least one of the second normal product image belonging to the normal classification to generate an abnormal modified image belonging to an abnormal classification;
inputting, by the processor, the abnormal modified image into the image restoration model to acquire an abnormal restored image output from the image restoration model;
acquiring, by the processor, an inspection product image for a product to be inspected,
inputting, by the processor, the inspection product image into the image restoration model, and acquiring a restored inspection product image output from the image restoration model; and
determining, by the processor, whether the product to be inspected is defective by using a distance between a first expression vector of the inspection product image and a second expression vector of the restored inspection product image.

11. The method of claim 10, wherein the step of training the image restoration model includes a step of training the image restoration model so that a mean square error (MSE) of a pixel value of the first normal product image and a pixel value of the first normal restored image is minimized.

12. The method of claim 10, wherein the step of modifying the first normal product image includes a step of applying at least one of brightness change, color change, contrast change, rotation, and rescale to the first normal product image to generate the second normal product image belonging to the normal classification and increase the number of the second normal product image.

13. The method of claim 12, wherein the step of modifying the second normal product image includes a step of applying at least one of cut-out, cut-paste, and noise addition to the at least one second normal product image belonging to the normal classification to generate the abnormal modified image belonging to the abnormal classification.

14. The method of claim 10, further comprising the step of:
training, by the learning processor, a feature extraction model by inputting the second normal product image belonging to the normal classification, the abnormal modified image, and the abnormal restored image as learning data into the feature extraction model which outputs an expression vector for the input image data.

15. The method of claim 14, wherein the step of training the feature extraction model includes the step of performing contrastive learning on the feature extraction model so that a distance between an expression vector of the second normal product image belonging to the normal classification and an expression vector of the abnormal restored image is less than a distance between an expression vector of the abnormal modified image and the expression vector of the abnormal restored image.

16. The method of claim 14, wherein the step of training the feature extraction model includes the steps of:
inputting the second normal product image belonging to the normal classification as positive sample input data into the feature extraction model;
inputting the abnormal modified image as negative sample input data into the feature extraction model;
inputting the abnormal restored image as anchor input data into the feature extraction model; and
training the feature extraction model through a triplet loss function.

17. The method of claim 10, wherein the step of determining whether the product to be inspected is defective includes the steps of:
acquiring a distance between the first expression vector and the second expression vector; and
determining whether the product to be inspected is defective according to the distance between the first expression vector and the second expression vector.

18. The method of claim 17, wherein the step of determining whether the product to be inspected is defective further includes the steps of:
determining that the product to be inspected is normal when the distance between the first expression vector and the second expression vector is less than or equal to a predetermined defect reference value; and
determining that the product to be inspected is defective when the distance between the first expression vector and the second expression vector exceeds the predetermined defect reference value.
